(19) United States
(12) Patent Application Publication
(10) Pub. No.: US 2024/0411710 A1
(43) Pub. Date: Dec. 12, 2024

(54) METHODS TO USE TENSOR MEMORY ACCESS IN COMPUTE EXPRESS LINK COMMUNICATIONS

(71) Applicant: Micron Technology, Inc., Boise, ID (US)

(72) Inventors: Fa-Long Luo, San Jose, CA (US); Jaime Cummins, Bainbridge Island, WA (US)

(73) Assignee: Micron Technology, Inc., Boise, ID (US)

(21) Appl. No.: 18/734,847

(22) Filed: Jun. 5, 2024

Related U.S. Application Data
(60) Provisional application No. 63/507,177, filed on Jun. 9, 2023.

(51) Int. Cl. G06F 13/16; G06F 13/42

(52) U.S. Cl. CPC G06F 13/1642; G06F 13/1694; G06F 13/4221

(57) ABSTRACT

An example of compute express link (CXL) system includes a memory, and a tensor access circuit having a memory mapper configured to configure a memory map based on a compute express link (CXL) command associated with an access operation of the memory. The memory map includes a specific sequence of CXL instructions to access to the memory via a CXL bus.

### CROSS REFERENCE TO RELATED APPLICATION(S)

This application claims the benefit under 35 U.S.C. § 119 of the earlier filing date of U.S. Provisional Application Ser. No. 63/507,177 filed Jun. 9, 2023 the entire contents of which are hereby incorporated by reference in their entirety for any purpose.

### BACKGROUND

High speed memory access, and reduced power consumption are some of the features that are demanded from semiconductor devices. In recent years, systems that have adopted multi-core processors for the execution of applications have resulted in faster access patterns to a storage device, and also more random access patterns. For example, a storage device may repeat a typical access pattern (e.g., a dynamic, random-access memory (DRAM) may repeat, in order, bank activation, read access or write access, and bank precharge during an access operation). Access patterns to a storage device for faster access are needed. The efficiency and performance of a computing device may be affected by different storage devices. Accordingly, a need exists for fast and efficient access patterns.

Tensors, which are generally geometric objects related to a linear system, may be utilized in machine learning and artificial intelligence applications. Tensor processing may include processing of matrix algebra or other linear systems analysis. Such processing may be intensive and repetitive, in that a common operand may be utilized several times, for example; in layered processing of tensors. Such repetition, combined with speed of processing, may necessitate repeated memory access to perform operations for tensor processing.

### BRIEF DESCRIPTION OF THE DRAWINGS

FIGS. 1A-1C are schematic illustrations of respective tiers of compute express link (CXL) computing systems, respectively, configured to implement tensor memory access operations in accordance with embodiments described herein.

FIG. 2 is a schematic illustration of a computing system arranged in accordance with embodiments described herein.

FIG. 3 is an illustration of access patterns of a CXL memory unit in accordance with embodiments described herein.

FIG. 4 is a flowchart of a method to perform a tensor access operation using CXL protocols in accordance with embodiments described herein.

FIG. 5 is a schematic illustration of a computing system having a computing device arranged in accordance with embodiments described herein.

### DETAILED DESCRIPTION

Certain details are set forth below to provide a sufficient understanding of embodiments of the present disclosure. However, it will be clear to one skilled in the art that embodiments of the present disclosure may be practiced without various of these particular details. In some instances, well-known computing device components, circuits, control signals, timing protocols, computing system components, and software operations have not been shown in detail in order to avoid unnecessarily obscuring the described embodiments of the present disclosure.

Generally, compute express link (CXL) is an open standard, industry-supported cache-coherent interconnect for processors, memory expansion, and accelerators. Essentially, CXL technology maintains memory coherency between the central processing unit (CPU) memory space and memory on attached devices. This may enable resource sharing (or pooling) for higher performance, reduce software stack complexity, and/or lower overall system cost. CXL units (e.g., devices, systems, chips, components, etc.) are units capable of communicating using CXL. CXL units generally fall into one of three categories or tiers: caching devices/accelerators (e.g., Tier 1 CXL units); graphics processing units (GPUs), application-specific integrated circuits (ASICs), and field-programmable gate arrays (FPGAs) equipped with double data rate (DDR) dynamic, random-access memory (DRAM) or high bandwidth memory (HBM) (e.g., Tier 2 CXL units); or memory buffers configured to provide additional bandwidth and capacity to host processors independent of the host processor's memory (e.g., Tier 3 CXL units).

For the Tier 1 CXL units, accelerators, such as smart network interface controllers (NICs) (e.g., partitioned global address space (PGAS) NICs, NIC atomics, etc.) may lack local memory, so these devices may use CXL to communicate with the host processor's DDR DRAM. For Tier 2 CXL units, CXL may be used to make the host processor's memory locally available to the Tier 2 CXL units—and the Tier 2 CXL units' memory locally available to the host processor. For the Tier 3 CXL units, the host processor may utilize CXL to communicate with additional memory buffers (e.g., memory devices) in order to expand memory bandwidth and/or capacity expansion beyond the memory of the host processor.

CXL units may use one or more CXL protocols to receive and execute read and write commands from a host processor, memory controller, and/or directly from a computing device or network sending a memory command. CXL units may receive the read or write commands as a sequence of CXL instructions, with each instruction corresponding to a specific location identified by an address to store data to or retrieve data from. For example, a read command may be processed by a host processor or a memory controller as a request to read a specific address of a specific CXL unit. Such a command may be sent to a CXL unit as an instruction to access that location of the CXL unit. An instruction may include such addressable information (e.g., row/column of storage cell and/or a logical address that points to a row/column of a storage cell), as determined by the host processor or memory controller based on the read command. For example, the location of the CXL unit may be at a particular physical storage cell in a logical CXL storage partition of the CXL unit. In an example of a memory array as a CXL unit, the host processor or the memory controller may perform circuitry operations (e.g., charging row or column lines) to access particular physical memory cell. Such circuitry operations can be time-consuming and power consuming. Similarly, the host processor or memory controller determining which logical storage partition of the CXL unit may include the requested information that can be accessed at a specific access rate can be a time-consuming and power consuming process for execution of CXL commands.

In accessing specific storage cells of a CXL unit, read or write commands may not differentiate where, physically, the requested information is stored in the CXL unit. Also, a host processor and/or a memory controller may not send instructions to the CXL units based on any pattern in which information has been stored in a CXL unit. CXL units may receive write commands and, thereby, process writing to a CXL unit, without regard to the specifics of an operation being performed or implemented in a processor or computing device. For example, a CXL unit may receive a write command, and store information associated with that write command to a specific location in memory of the CXL unit that has been determined to be available. As described herein, advantageously, operations being performed or implemented in a processor or computing device, may include executing CXL commands as defined by that operation being performed. For example, a specific sequence of CXL access instructions to access a storage cell of a storage array of a CXL unit may include a sequence of CXL access instructions defined by an operation order of the CXL command. For example, CXL units may be accessed as described herein in a particular pattern which may facilitate tensor operations. Tensor operations may utilize matrix data, and accordingly may seek to read and/or write data in a particular pattern (e.g. diagonal, etc.) In examples of a diagonal calculation for a matrix operation, a sequence of CXL access instructions may access various storage cells along a diagonal of a storage array, in accordance with a diagonal CXL command implemented by a host processor and/or a memory controller coupled to that CXL unit including such a storage array. It is noted that, in some examples, CXL units may be configured to perform similar access operations associated with processor memory using similar CXL protocols.

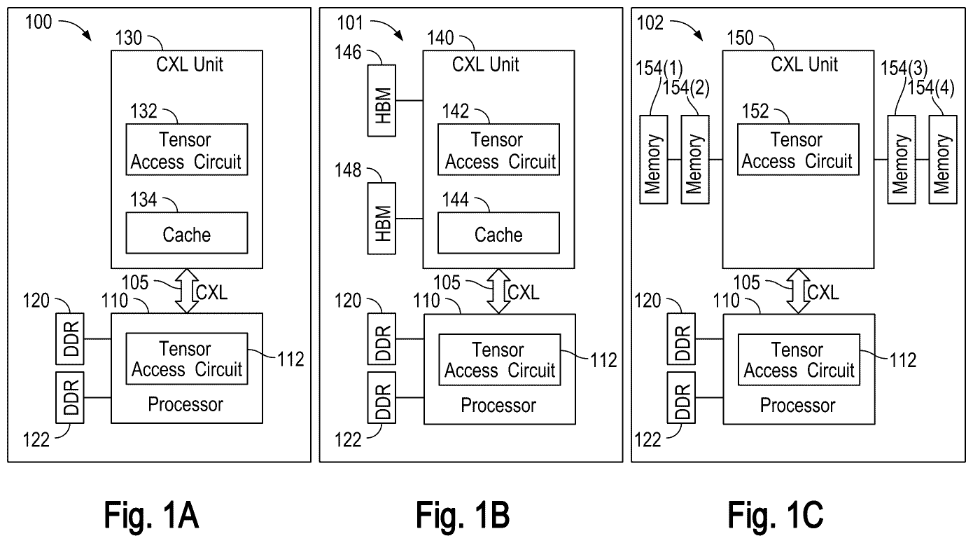

FIGS. 1A-1C are schematic illustrations of respective tiers of compute express link (CXL) computing systems 100, 101, and 102, respectively, configured to implement tensor memory access operations in accordance with embodiments described herein. The respective tiers of the CXL computing systems 100, 101, and 102 of FIGS. 1A-1C may include common elements, and those elements have been identified in FIGS. 1A-1C using the same reference numbers. Consequently, a detailed description of the operation of these particular elements will not be repeated for all three FIGS. 1A-1C in the interest of brevity.

Turning to FIG. 1A, the Tier 1 CXL computing system 100 may include a processor 110 coupled to a CXL unit 130 via a CXL bus 105. The processor 110 may be coupled to dedicated memory 120, 122. The processor 110 may include a tensor access circuit 112 configured to support tensor memory access operations. The CXL unit 130 may include hardware for specific applications, such as a smart NIC for processing network data (e.g., PGAS NICs, NIC atomics, etc.). In some examples, the CXL unit 130 may include a small cache memory 134 or no local memory at all. Because the CXL unit 130 may lack any or sufficient local memory, the CXL unit 130 may utilize the CXL bus 105 to communicate with the dedicated memories 120 and 122 via the processor 110. The CXL unit 130 may include a tensor access circuit 132 to support tensor access operations.

Turning to FIG. 1B, the Tier 2 CXL computing system 101 may include the processor 110 coupled to a CXL unit 140 via the CXL bus 105. The CXL unit 140 may include hardware for specific applications, such GPUs, ASICs, and FPGAs equipped with a small cache memory 144, as well as double data rate (DDR) dynamic, random-access memory (DRAM) or high bandwidth memories (HBM) (memories) 146, 148. In this example, the CXL bus 105 may facilitate pooling of the memories of the processor 110 (e.g., the memories 120, 122) with the memories of the CXL unit 140 (e.g., the memories 146, 148). The CXL unit 140 may include a tensor access circuit 142 to support tensor access operations.

Turning to FIG. 1C, the Tier 3 CXL computing system 102 may include the processor 110 coupled to a CXL unit 150 via the CXL bus 105. The CXL unit 150 may include memories 154(1)-(4), and the processor 110 may utilize the CXL bus 105 to communicate with the CXL unit 150 to access the memories 154(0)-(3) to expand memory bandwidth and/or capacity expansion beyond the memories 120, 122 of the processor 110. The CXL unit 150 may include a tensor access circuit 152 to support tensor access operations.

The processor 110 and the CXL unit 130, the CXL unit 140, and/or the CXL unit 150 (CXL unit) may use the CXL bus 105 to communicate various commands back and forth, including respective receive read and write commands to retrieve or store data at one of the memories 120, 122, 134, 144,146, 148, and 154(1)-(4). The CXL unit may receive read or write commands from the processor 110 as a sequence of instructions, with each instruction corresponding to a specific location identified by an address to store data to or retrieve data from. For example, a read command may be processed the processor 110 as a request to read a specific address of a specific memory of the CXL unit. Such a command may be sent to the CXL unit as an instruction to access that location of the CXL unit. The instruction may include such addressable information (e.g., row/column of storage cell and/or a logical address that points to a row/column of a storage cell), as determined by the processor 110 based on the read command. For example, the location of one of the memories of the CXL unit may be at a particular physical storage cell in a logical CXL storage partition of the CXL unit. In an example of a memory array of a memory as a CXL unit, the processor 110 may perform circuitry operations (e.g., charging row or column lines) to access particular physical memory cell. Similar operations may be initiated by the CXL units to access memories 120, 122 of the processor 110. Such circuitry operations can be time-consuming and power consuming. Similarly, the processor 110 and/or the CXL units determining which logical storage partition of the target memory may include the requested information that can be accessed at a specific access rate can be a time-consuming and power consuming process for execution of access commands.

In accessing specific storage cells of the processor 110 or one of the CXL units, read or write commands may not differentiate where, physically, the information requested is stored in the CXL unit. Also, the processor 110 may not send instructions to the CXL units based on any pattern in which information has been stored in a CXL unit, and vice versa. The CXL units (or the processor 110) may receive write commands and, thereby, process writing to a memory of the CXL unit (or the processor 110), without regard to the specifics of an operation being performed or implemented in the processor 110 or the CXL unit. For example, a CXL unit may receive a write command, and store information associated with that write command to a specific location in a memory of the CXL unit that has been determined to be available. As described herein, advantageously, operations being performed or implemented in a processor or computing device, may include executing CXL commands as defined by that operation being performed. For example, a specific sequence of CXL access instructions to access a storage cell of a storage array of a CXL unit may include a sequence of CXL access instructions defined by an operation order of the CXL command. For example, memories of the CXL units and/or the processor 110 may be accessed as described herein in a particular pattern which may facilitate tensor operations. Tensor operations may utilize matrix data, and accordingly may seek to read and/or write data in a particular pattern (e.g. diagonal, etc.) In examples of a diagonal calculation for a matrix operation, a sequence of CXL access instructions may access various storage cells along a diagonal of a storage array, in accordance with a diagonal CXL command implemented by the CXL unit and/or the processor 110 coupled to a memory including such a storage array.

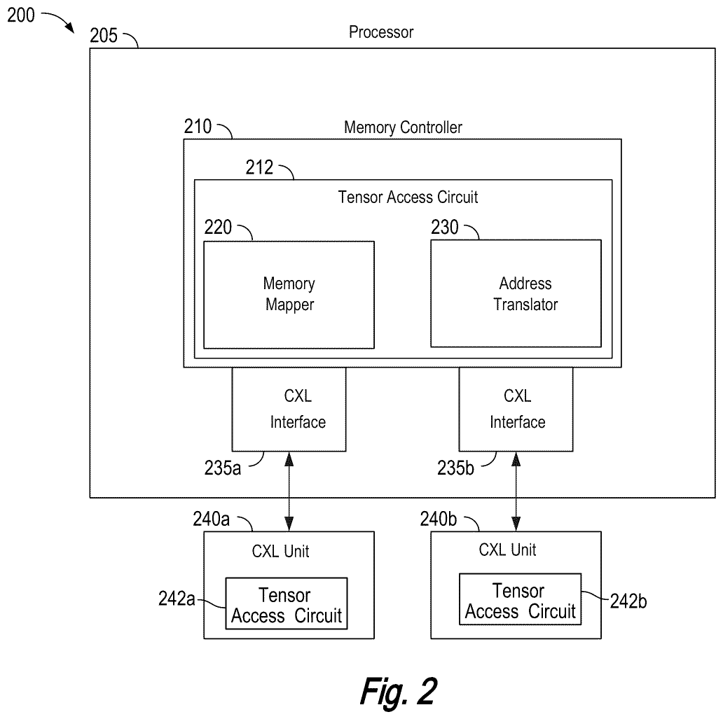

FIG. 2 is a schematic illustration of a computing system 200 arranged in accordance with embodiments described herein. In some examples, the Tier 1 CXL computing system 100 of FIG. 1A, the Tier 2 CXL computing system 101 of FIG. 1B, and/or the Tier 3 CXL computing system 102 of FIG. 1C may implement the computing system 200, in some examples. The computing system 200 includes a processor 205 coupled to compute express link (CXL) units 240a, 240b. The CXL units 240a, 240b may include caching devices/accelerators, accelerators with memory, memory buffers with memory, or any combination thereof. The CXL units 240a, 240b may implement any of the CXL unit 130 of FIG. 1A, the CXL unit 140 of FIG. 1B, the CXL unit 150 of FIG. 1C, or any combination thereof. The processor may implement a memory controller 210 that includes a tensor access circuit 212 having a memory mapper 220 and an address translator 230. The memory controller 210 may be coupled to the CXL units 240a, 240b via CXL interfaces 235a, 235b. The CXL units 240a, 240b may each include a respective tensor access circuit 242a, 242b. Portions of the foregoing discussion will focus on the tensor access circuit 212 accessing or communicating with the CXL units 240a, 240b. Similar, corollary operations may be performed by the tensor access circuits 242a, 242b of the CXL units 240a, 240b to communicate with and/or access memory coupled to the processor 205. A detailed description of these operations is not included for the sake of brevity.

The processor 205 may implement CXL commands received from various data sources or processes being executed on the processor 205. For example, the processor 205 may receive CXL memory access requests (e.g., read or write commands) from a process being executed on the processor 205. In such a case, the memory controller 210 may process the CXL memory access requests, as implemented by the processor 205, to access memory of one or more of the CXL units 240a, 240b.

The processor 205 may be used to implement a memory system of the computing system 200 utilizing the memory controller 210. The processor 205 may be a multi-core processor in some examples that includes a plurality of cores. The plurality of cores may for example be implemented using processing circuits which read and execute program instructions independently. The memory controller 210 may handle communication with the memory system that may be outside of the processor 205. For example, the memory controller 210 may provide CXL access commands to the CXL units 240a, 240b from the plurality of cores of the processor 205. The memory controller 210 may provide such access commands via CXL interfaces 235a, 235b. For example, the CXL interfaces 235a, 235b may provide a clock signal, a command signal, and/or an address signal to any of the CXL units 240a, 240b. While writing data by storing the data in the CXL units 240a, 240b, the memory controller 210 provides instructions to write data to the CXL units 240a, 240b based on a write command. While reading the stored data from the CXL units 240a, 240b, the memory controller 210 provides instructions based on a read command and receives the data from the CXL units 240a, 240b.

The memory controller 210 may be implemented using circuitry which controls the flow of data to the CXL units 240a, 240b. The memory controller 210 may be a separate chip or integrated circuit coupled to the processor 205 or being implemented on the processor 205, for example, as a core of the processor 205 to control the memory system of the computing system 200. In some embodiments, the memory controller 210 may be integrated into the processor 205 to be referred to as integrated memory controller (IMC).

The memory controller 210 may communicate with a plurality of CXL units to implement a computing system with the processor 205. For example, the CXL units 240a, 240b, may communicate simultaneously with the memory controller 210. While the example of FIG. 2 depicts two CXL units 240a, 240b, it can be expected that the memory controller 210 may interact with any number of CXL units. For example, eight CXL units may be included and each CXL unit may include a data bus having an eight-bit width, thus the memory system implemented by the processor 205 may have a sixty-four bit width. The CXL units 240a, 240b may include or be coupled to memories, such as cache memory, dynamic random-access memory (DRAM) or nonvolatile random-access memory (RAM), such as ferroelectric RAM (FeRAM), spin-transfer-torque RAM (STT-RAM), phase-change RAM (PCRAM), resistance change RAM (ReRAM), or the like. In various embodiments, such CXL units may include memory chips, memory modules, memory dies, memory cards, memory devices, memory arrays, and/or memory cells. Physically, memories of the CXL units 240a, 240b may be arranged and disposed as one layer, or may be disposed as stacked layers. In some embodiment, memories of the CXL units 240a, 240b may be disposed as multiple layers, on top of each other, to form vertical memory, such as 3D NAND Flash memory.

In some examples where memories of the CXL units 240a, 240b are implemented using DRAM or non-volatile RAM integrated into a single semiconductor chip, memories of the CXL units 240a, 240b may be mounted on a memory module substrate, a mother board or the like. For example, memories of the CXL units 240a, 240b may be referred to as memory chips. The memories of the CXL units 240a, 240b may include a memory cell array region and a peripheral circuit region. The memory cell array region includes a memory cell array with a plurality of banks, each bank including a plurality of word lines, a plurality of bit lines, and a plurality of memory cells arranged at intersections of the plurality of word lines and the plurality of bit lines. The selection of the bit line may be performed by a plurality of column decoders and the selection of the word line may be performed by a plurality of row decoders.

The peripheral circuit region of the memories of the CXL units 240a, 240b may include clock terminals, address terminals, command terminals, and data input/output (I/O) terminals (DQ). For example, the data I/O terminals may handle eight-bit data communication. Data input output (I/O) buffers may be coupled to the data input/output terminals (DQ) for data accesses, such as read accesses and write accesses of memories. The address terminals may receive address signals and bank address signals. The bank address signals may be used for selecting a bank among the plurality of banks. A row address and a column address may be provided as address signals. The command terminals may include a chip select (/CS) pin, a row address strobe (/RAS) pin, a column address strobe (/CAS) pin, a write enable (/WE) pin, and/or the like. A command decoder may decode command signals received at the command terminals from the memory controller 210 via one of the CXL interfaces 235a, 235b, to receive various commands including a read command and/or a write command. Such a command decoder may provide control signals responsive to the received commands to control the memory cell array region. The clock terminals may be supplied with an external clock signal, for example from one of the CXL interfaces 235a, 235b.

The memory mapper 220 of the memory controller 210 may provide a memory map to the memory units for access to the memory units. For example, the memory map may be selected according to a CXL command provided to access the CXL unit 240a and/or the CXL unit 240b. For example, a read or write operation of a process or program being implemented on the processor 205 may be a CXL memory access operation that sends a read or write command to the memory controller 210. The memory mapper 220 may retrieve or configure a memory map based on a CXL command associated with that CXL memory access operation. The memory map may include one or more specific sequences of memory access instructions to access memories of CXL units (e.g. CXL unit 240a and/or CXL unit 240b). For example, the specific sequence of memory access instructions may access one or more memory cells of a memory array in a particular pattern which may be advantageous for performing a tensor and/or matrix operation. Each memory access instruction may include an instruction for a respective address of a memory cell of the plurality of memory cells. For example, the memory map may be provided to the CXL unit 240a via an address terminal of the CXL interface 235a to an address terminal of the CXL unit 240a.

The memory mapper may generate, provide, and/or select the memory map to be specific to a type of memory command. CXL memory commands may include row memory commands or column memory commands, such as to access a respective row or column of a memory array. CXL commands may also include commands based on an operation being performed or implemented on the processor 205. Tensor operations may include various matrix operations and/or computations. For example, a tensor operation may include the calculation of a diagonal of a specific matrix or a determinant of a specific matrix; for example, the latter being part of a matrix inverse computation.

The memory mapper 220 may provide a memory map such that memory is accessed as defined by an order of operation of a tensor CXL command. Tensor CXL commands may include a diagonal memory command, a determinant memory command, or any matrix memory command. For example, a specific sequence of memory access instructions to access memory cell of a memory array may include a sequence of memory access instructions defined by an operation order of a tensor CXL command. In some examples of a diagonal calculation for a matrix operation, a sequence of memory access instructions may access various memory cells along a diagonal of a memory array, in accordance with a diagonal memory command being implemented by the processor 205, as part of a tensor operation being performed on the processor 205. Accordingly, in providing a memory map for a memory command, the memory mapper 220 may identify a plurality of memory addresses of one or more CXL units 240a, 240b to access that corresponding memory address; and, thereby, allocate the plurality of memory addresses into the memory map according to an operation order of the memory command, such that the specific sequence of instructions execute in that operation order.

The memory mapper 220 may provide a memory map that may be based on a tensor CXL command for a memory unit of the CXL units 240a, 240b having a three-dimensional memory array. The memory map may specify that each layer of the three-dimensional memory array is stored according to a respective layer of tensor processing. Tensor operations may be carried out on three-dimensional structures; and, as described herein, the memory map may be used to efficiently access memory of the CXL units 240a, 240b based on that three-dimensional structure of the tensor operation. Tensor operations on a three-dimensional matrix may include operations based on modes, such as a vertical column mode, a row mode, a tube mode, a vertical slice mode, a lateral slice mode, and/or a frontal sliced mode. Each mode may correspond to a two-dimensional vector or plane of a respective axis of the three-dimensional operation; and, accordingly, a memory may be accessed, such as reading or writing, memory in like manner. Advantageously, in some examples, accessing memory in three dimensions may allow more efficient processing of tensors; for example, in machine learning applications.

Advantageously, in some examples, for tensor CXL commands, system and methods described herein may be utilized as a memory access scheme in processing of tensors or performing tensor operations, such as tensor decomposition. Tensor-based processing may compute several layers of data to be processed, with each subsequent layer being based on a combination of the previous layer's results. In some applications, layers may be stored in memories of the CXL units 240a, 240b so that subsequent processing of layers may be performed more efficiently. For example, a layer may be written diagonally in a two-dimensional memory array or three-dimensional memory device. The memory mapper 220 may provide a memory map arranged to access such a memory unit in a diagonal fashion, as specified by the order of operations in that tensor CXL command. In some examples, the tensor CXL command may include processing each previous layer's results by initially writing each layer's result in the memory unit as a diagonal. Accordingly, the memory unit may also be accessed to process that diagonal computation in the way where each layer's results were written according to the tensor CXL command. In this manner, any memory unit or device may be accessed in accordance with tensor memory access, which may be, as described herein, access to memory defined by an operation order of tensor processing.

While the memory mapper 220 has been described in the context of an implementation of the processor 205 as part of the memory controller 210, it can be expected that the memory mapper 220 may also be implemented differently in other embodiments. Additionally or alternatively, the memory mapper 220 may be implemented in the CXL units 240a, 240b to support accessing memory of the processor 205. In addition, the memory mapper 220 may be coupled to the processor 205 as a separate circuit such as an application specific integrated circuits (ASIC), a digital signal processor (DSP) implemented as part of a field-programmable gate array (FPGA), or a system-on-chip (SoC). As another example, the memory mapper 220 may be coupled to the memory controller 210, being implemented by the processor 205, as a series of switches that determine the sequence of instructions that are to be performed on a CXL unit 240a, 240b. The switches may be multiplexors, for example, with selected lines coupled to the memory controller 210.

The address translator 230 of the memory controller 210 may translate a memory map for a memory unit based on a CXL command to access a memory of the CXL unit 240a and/or the CXL unit 240b. A memory map may be translated when an operation order of a CXL command is different from an operation order of a previous CXL command that was provided to perform a previous memory access operation at CXL unit 240a and/or the CXL unit 240b. For example, the memory mapper 220 may have previously provided a memory map based on a diagonal command, and, subsequently, the memory mapper 220 received a command from the memory controller 210 to provide a memory map for a determinant CXL command. In such examples, the address translator 230 may identify the addresses of the memory cells in the memory map utilized for the diagonal memory command. Once identified, the address translator 230 may allocate the identified addresses into a memory map configured for the determinant memory command, such that determinant memory command accesses the identified addresses in an operation order defined by a determinant operation, rather than a diagonal memory operation in which order the memory cells had been previously accessed. Once allocated, the address translator 230 completes translation of the memory map for the determinant CXL command, and the memory mapper 220 may provide the translated memory map to the CXL unit 240a and/or the CXL unit 240b.

While the address translator 230 has been described in the context of an implementation of the processor 205 as part of the memory controller 210, it can be expected that the address translator 230 may also be implemented differently in other embodiments. Additionally or alternatively, the address translator 230 may be implemented in the CXL units 240a, 240b to support accessing memory of the processor 205. The address translator 230 may be coupled to the processor 205 as a separate circuit such as the ASIC, a digital signal processor (DSP) implemented as part of a field-programmable gate array (FPGA), or a system-on-chip (SoC). As another example, the address translator 230 may be coupled to the memory controller 210, being implemented by the processor 205, as a series of switches that identify respective addresses of a CXL unit 240a, 240b to translate those identified addresses for a different memory map. The switches may be multiplexors, for example, with selected lines coupled to the memory controller 210.

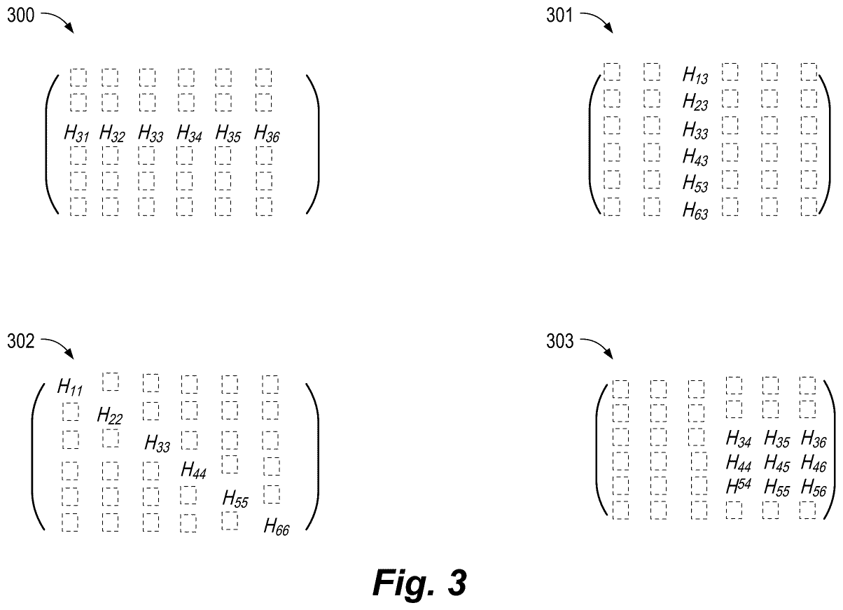

FIG. 3 is an illustration of access patterns of a CXL memory unit in accordance with embodiments described herein. Access pattern 300 is an illustration of a CXL memory unit being accessed in accordance with a row access mode as part of a tensor CXL access operation. As shown in the access pattern 300, within a 6×6 memory cell array, the row three is being accessed during the row access mode. Access pattern 301 is an illustration of a CXL memory unit being accessed in accordance with a column access mode as part of a tensor CXL access operation. As shown in the access pattern 301, within a 6×6 memory cell array, the column three is being accessed during the column access mode. Access pattern 302 is an illustration of a CXL memory unit being accessed in accordance with a diagonal access mode as part of a tensor operation. As shown in the access pattern 302, within a 6×6 memory cell array, a diagonal line of memory cells starting from the upper, left corner and ending at the lower, right corner are being accessed during the diagonal access mode. Access pattern 303 is an illustration of a memory unit being accessed in accordance with a sub-matrix access mode as part of a tensor CXL access operation. As shown in the access pattern 303, within a 6×6 memory cell array, a 3×3 sub-matrix of memory cells (starting with cell (3, 4)) are being accessed during the sub-matrix access mode. Different or additional access patterns and corresponding access modes may be implemented without departing from the scope of the disclosure.

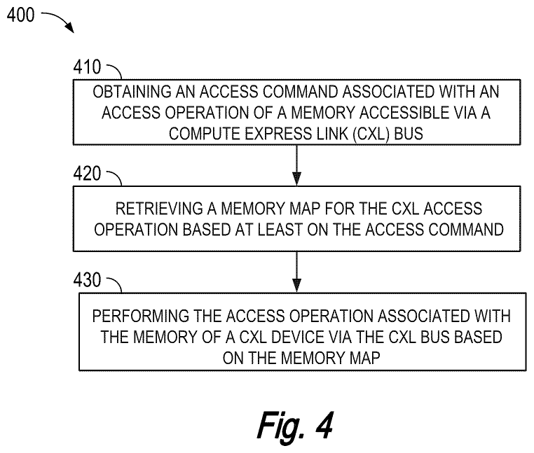

FIG. 4 is a flowchart of method 400 to perform a tensor access operation using CXL protocols in accordance with embodiments described herein. The method 400 may be performed by any of the processor 110 of FIGS. 1A-1C, the CXL unit 130 of FIG. 1A, the CXL unit 140 of FIG. 1B, the CXL unit 150 of FIG. 1C, and/or the processor CXL bus 105 and/or the CXL units 240a, 240b of FIG. 2, in some examples.

The method 400 may include obtaining an access command associated with an access operation of a memory accessible via a compute express link (CXL) bus, at 410. The access command may be a CXL access command associated with a read or write operation of a memory.

The method 400 may further include retrieving a memory map for the access operation based at least on the access command, at 420. In some examples, the memory map includes a specific sequence of memory access instructions to access a plurality of memory cells of the memory. In some examples, the memory map is based on an operation order of the access command. In some examples, the memory map may be generated by a memory mapper, such as the memory mapper 220 of FIG. 2. In some examples, the method 400 further includes retrieving a memory map from a memory coupled to a processor.

The method 400 may further include performing the access operation associated with the memory of a CXL device via the CXL bus based on the memory map, at 430. In some examples, the method 400 further includes accessing respective addresses of the plurality of memory cells based on the memory map to perform the access operation via the CXL bus.

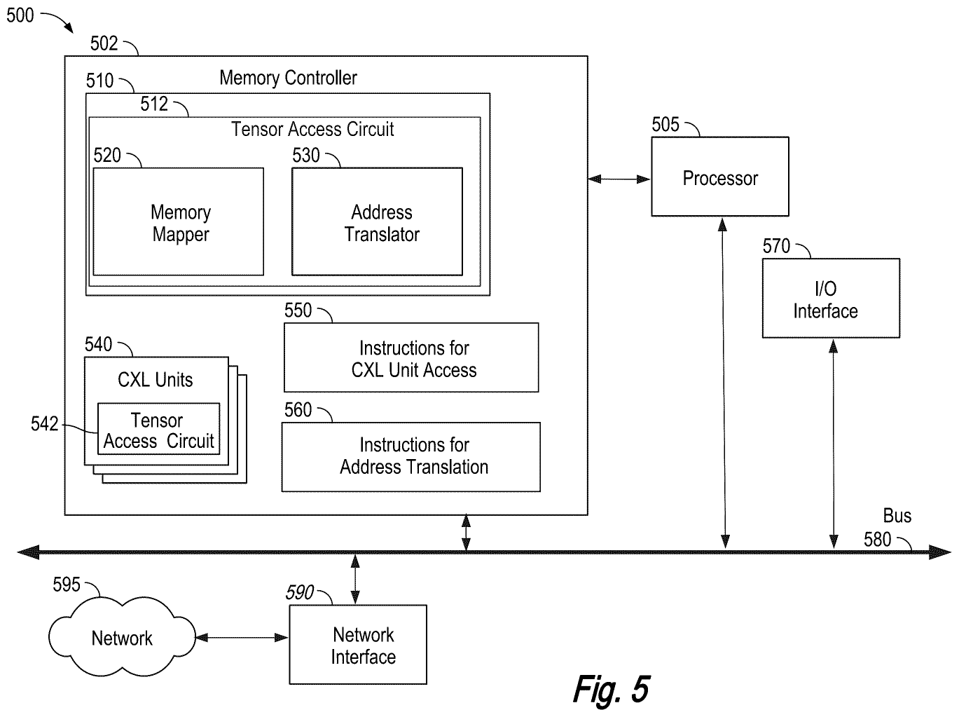

FIG. 5 is a schematic illustration of a computing system 500 having a computing device 502 arranged in accordance with embodiments described herein. The computing device 502 may operate in accordance with any embodiment described herein. The computing device may be a smartphone, a wearable electronic device, a server, a computer, an appliance, a vehicle, or any type of electronic device. The computing system 500 includes a memory system 502, a processor 505, and I/O interface 570, and a network interface 590 coupled to a network 595. The memory system 502 includes a memory controller 510 having a tensor access circuit 512 with a memory mapper 520 and address translator 530, with both operating according to the functionality described herein with respect to a memory mapper and an address translator. Similarly numbered elements of FIG. 5 include analogous functionality to those numbered elements of FIG. 2. For example, the CXL units 540 having the tensor access circuits 542 may operate and be configured like the CXL units 240a, 240b of FIG. 2. Processor 505 may include any type of microprocessor, central processing unit (CPU), an application specific integrated circuits (ASIC), a digital signal processor (DSP) implemented as part of a field-programmable gate array (FPGA), a system-on-chip (SoC), or other hardware to provide processing for the computing system 500.

The memory system 502 also includes CXL units 540 and non-transitory hardware readable medium 550, 560 including instructions, respectively, for memory access and address translation. The processor 505 may control the memory system 502 with control instructions that indicate when to execute the instructions for CXL unit access 550 and/or the instructions for address translation 560. Upon receiving such control instructions, the memory mapper 520 may execute the instructions for CXL unit access 550; and/or the address translator 530 may execute the instructions for address translation 560. The instructions for CXL unit access 550 may include a program that executes the method 400. The instructions for address translation 560 may include a program that executes the method 400. Communications between the processor 505, the I/O interface 570, and the network interface 590 are provided via a processor internal bus 580. The processor 505 may receive control instructions from the I/O interface 570 or the network interface 590, such as instructions to control execution of memory access or address translation.

Bus 580 may include one or more physical buses, communication lines/interfaces, and/or point-to-point connections, such as Peripheral Component Interconnect (PCI) bus. The I/O interface 570 can include various user interfaces including video and/or audio interfaces for the user, such as a tablet display with a microphone. Network interface 590 communications with other computing devices, such as computing device 500 or a cloud-computing server, over the network 595. For example, the network interface 590 may be a USB interface.

While certain features and aspects have been described with respect to exemplary embodiments, one skilled in the art will recognize that various modifications and additions can be made to the embodiments discussed without departing from the scope of the invention. Although the embodiments described above refer to particular features, the scope of this invention also includes embodiments having different combination of features and embodiments that do not include all of the above described features. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture, but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, various procedures may be reordered, added, and/or omitted in accordance with various embodiments. The procedures described with respect to one method or process may be incorporated within other described methods or processes; likewise, hardware components described according to a particular structural architecture and/or with respect to one system may be organized in alternative structural architectures and/or incorporated within other described systems. Hence, while various embodiments are described with or without certain features for ease of description, the various components and/or features described herein with respect to a particular embodiment can be combined, substituted, added, and/or subtracted from among other described embodiments. Consequently, although several exemplary embodiments are described above, it will be appreciated that the invention is intended to cover all modifications and equivalents within the scope of the following claims.

What is claimed is:

1. An apparatus comprising:
a memory; and
a tensor access circuit having a memory mapper to configure a memory map based on a compute express link (CXL) command associated with an access operation of the memory, wherein the memory map comprises a specific sequence of CXL instructions to access to the memory via a CXL bus.

2. The apparatus of claim 1, wherein the specific sequence of CXL instructions is specific to a type of the CXL command.

3. The apparatus of claim 2, wherein the type of CXL command comprises a diagonal memory command, a determinant memory command, or any matrix memory command.

4. The apparatus of claim 1, wherein each CXL instruction of the specific sequence of CXL instructions comprises an instruction for a respective address of a memory cell of the memory.

5. The apparatus of claim 1, further comprising a memory controller including the tensor access circuit.

6. The apparatus of claim 5, further comprising a processor including the memory controller, wherein the processor is coupled to the memory via the CXL bus.

7. The apparatus of claim 6, further comprising a CXL device including the memory.

8. The apparatus of claim 1, further comprising a CXL device including the memory mapper.

9. The apparatus of claim 8, further comprising a processor coupled to the CXL device via the CXL bus, wherein CXL unit is configured to route the specific sequence of CXL instructions to the memory via the processor.

10. The apparatus of claim 1, further comprising a CXL interface coupled to the tensor access circuit and configured to communicate with the memory.

11. The apparatus of claim 10, wherein the memory mapper is configured to provide the memory map to the memory via the CXL interface.

12. An apparatus comprising:
a compute express link (CXL) device having a memory; and
a processor coupled to the CXL unit via a CXL bus and comprising having a tensor access circuit, wherein the tensor access circuit is configured to configure a memory map based on a CXL command associated with an access operation of the memory, wherein the memory map comprises a specific sequence of CXL instructions to access to the memory via the CXL bus.

13. The apparatus of claim 12, wherein a type of CXL command comprises a diagonal memory command, a determinant memory command, or any matrix memory command.

14. The apparatus of claim 12, wherein each CXL instruction of the specific sequence of CXL instructions comprises an instruction for a respective address of a memory cell of the memory.

15. The apparatus of claim 12, wherein the processor is configured to route the specific sequence of CXL instructions to the memory via the CXL bus.

16. A method comprising:
obtaining an access command associated with an access operation of a memory accessible via a compute express link (CXL) bus;
retrieving a memory map for the access operation based on the access command; and
performing the access operation associated with the memory of a CXL device via the CXL bus based on the memory map.

17. The method of claim 16, wherein the memory map includes a specific sequence of memory access instructions to access a plurality of memory cells of the memory.

18. The method of claim 16, further comprising accessing respective addresses of the plurality of memory cells based on the memory map to perform the access operation via the CXL bus.

19. The method of claim 16, wherein the memory map is based on an operation order of the access command.

20. The method of claim 16, further comprising retrieving a memory map from a memory coupled to a processor.
